(19) United States
(12) Patent Application Publication
(10) Pub. No.: US 2023/0329482 A1
(43) Pub. Date: Oct. 19, 2023

(54) PIZZA OVEN

(71) Applicant: Haohong Electric Technology (Hubei) Co., Ltd., Huanggang (CN)

(72) Inventor: Min WANG, Huanggang (CN)

(73) Assignee: Haohong Electric Technology (Hubei) Co., Ltd., Huanggang (CN)

(21) Appl. No.: 17/834,529

(22) Filed: Jun. 7, 2022

(30) Foreign Application Priority Data
Apr. 19, 2022 (CN) 202220910259.X

(51) Int. Cl. A47J 37/06; A47J 37/04

(52) U.S. Cl. CPC A47J 37/0658; A47J 37/046

(57) ABSTRACT

A pizza oven includes a shell, a heating mechanism and a turntable mechanism. An accommodating cavity is formed in the shell. The heating mechanism is configured for heating and baking pizza and arranged in the accommodating cavity. The turntable mechanism includes a turntable, a rotating shaft, a first transmission rod and a driving member. The turntable is arranged in the accommodating cavity, and the driving member is located outside the shell. A bottom of the turntable is connected to the rotating shaft. One end of the first transmission rod is drivingly connected to the rotating shaft, the other end of the first transmission rod is connected to the driving member through one side of the shell, and the driving member can drive the first transmission rod to rotate the rotating shaft to rotate the turntable. The present application can improve maintenance efficiency of the pizza oven.

### CROSS-REFERENCE TO RELATED APPLICATIONS

The present disclosure claims priority to Chinese Patent Application No. CN 202220910259.X, filed on Apr. 19, 2022, entitled “PIZZA OVEN”, which is hereby incorporated by reference in its entirety.

### TECHNICAL FIELD

The present application relates to the technical field of cooking utensils, in particular to a pizza oven.

### BACKGROUND

Pizza is a food made from sauces and fillings. At present, more and more people like pizza, and making pizza usually requires a professional pizza oven.

An existing pizza oven generally includes a heating mechanism and a turntable mechanism. Pizza raw materials are placed on the turntable mechanism. The heating mechanism heats and bakes the pizza raw materials. At the same time, the turntable mechanism drives the pizza raw materials to rotate, so that the pizza raw materials are heated evenly and delicious pizza is baked. As the turntable mechanism is arranged in the pizza oven, when the driving member of the turntable mechanism is damaged, it is difficult to replace or repair the driving member.

### SUMMARY

The main purpose of the present application is to provide a pizza oven, which aims to improve the maintenance efficiency of the pizza oven.

In order to achieve the above purpose, the pizza oven provided by the present application includes:
a shell formed with an accommodating cavity therein;
a heating mechanism arranged in the accommodating cavity and configured for heating and baking a pizza; and
a turntable mechanism comprising a turntable, a rotating shaft, a first transmission rod and a driving member,
wherein the turntable is arranged in the accommodating cavity, the driving member is located outside the shell, a bottom of the turntable is connected with the rotating shaft, one end of the first transmission rod is drivingly connected with the rotating shaft, and the other end of the first transmission rod is configured to pass through one side of the shell and connected with the driving member, and the driving member is configured to drive the first transmission rod to rotate the rotating shaft to rotate the turntable.

In an embodiment, the driving member is a hand crank, and a driving end of the hand crank is connected to the other end of the first transmission rod away from the rotating shaft.

In an embodiment, the driving member is a driving motor, and a driving end of the driving motor is connected to the other end of the first transmission rod away from the rotating shaft.

In an embodiment, the turntable mechanism further comprises a supporting beam arranged in the accommodating cavity, the supporting beam is provided with a rotating hole for the rotating shaft to pass through, and a bearing connected with the rotating shaft is arranged at the rotating hole of the supporting beam.

In an embodiment, the turntable mechanism further comprises a second transmission rod, one end of the second transmission rod is provided with a first transmission wheel connected with the rotating shaft, the other end of the second transmission rod is provided with a transmission gear connected with the first transmission rod, an end of the rotating shaft away from the turntable is provided with a second transmission wheel connected with the first transmission wheel, the one end of the first transmission rod away from the driving member is provided with a thread connected with the transmission gear.

In an embodiment, one end of the second transmission rod is provided with a first protective cover, and the other end of the second transmission rod is provided with a second protective cover, the first protective cover wrapping the first transmission wheel and the second transmission wheel, and the second protective cover wrapping the transmission gear and the thread.

In an embodiment, the heating mechanism comprises at least one heating tube located below the turntable.

In an embodiment, a first grille and a second grille are provided in the accommodating cavity, and the turntable is located between the first grille and the second grille.

In an embodiment, the shell is provided with an opening for taking out the pizza, an oven door is provided at the opening of the shell, and the oven door is provided with a door lock for controlling opening and closing of the oven door.

In an embodiment, a smoke exhaust pipe is arranged at a top of the shell and in communication with the accommodating cavity.

The embodiment of the present application arranges a driving member outside the shell, and the driving member is drivingly connected with the rotating shaft through the first transmission rod, which can drive the rotating shaft to rotate and drive the turntable to rotate, so that the pizza on the turntable is heated evenly, and the baking effect of the pizza oven baking the pizza is improved. Since the driving member is arranged outside the shell, when the driving member of the turntable mechanism is damaged, there is no need to disassemble the shell and take out the driving member from the accommodating cavity. Only the driving member outside the shell needs to be replaced or repaired directly. The operation is simple, and the maintenance efficiency of the pizza oven is improved.

### DETAILED DESCRIPTION OF THE DRAWINGS

In order to more clearly illustrate the embodiments of the present application or the technical solutions in the related art, the following will briefly introduce the drawings needed in the description of the embodiments or the related art. Obviously, the drawings in the following description are only some embodiments of the present application. For those of ordinary skill in the art, without creative labor, other drawings can also be obtained according to the structure shown in these drawings.

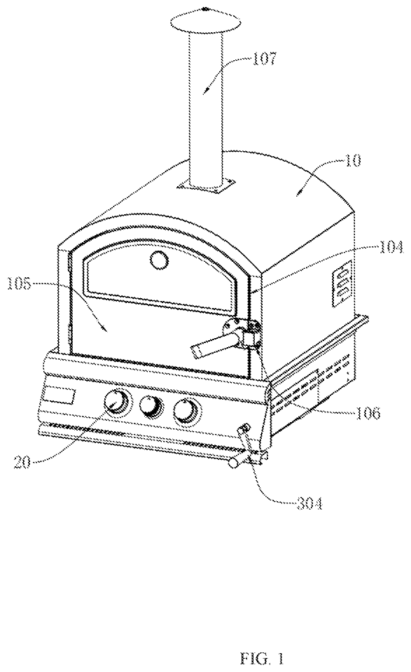

FIG. 1 is a schematic structural view of a pizza oven according to an embodiment of the present application.

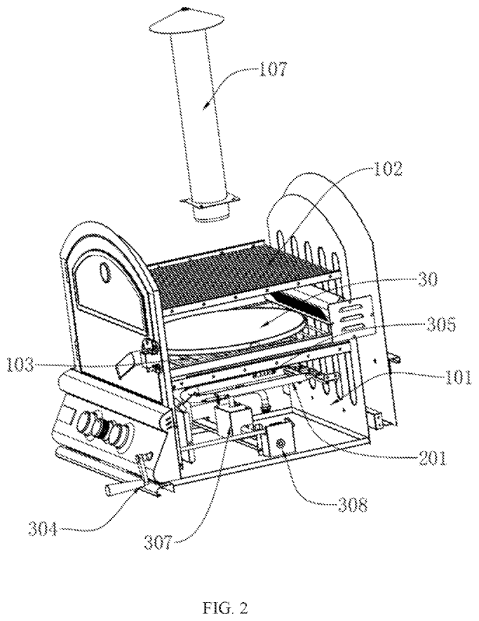

FIG. 2 is a schematic view of an internal structure of the pizza oven according to an embodiment of the present application.

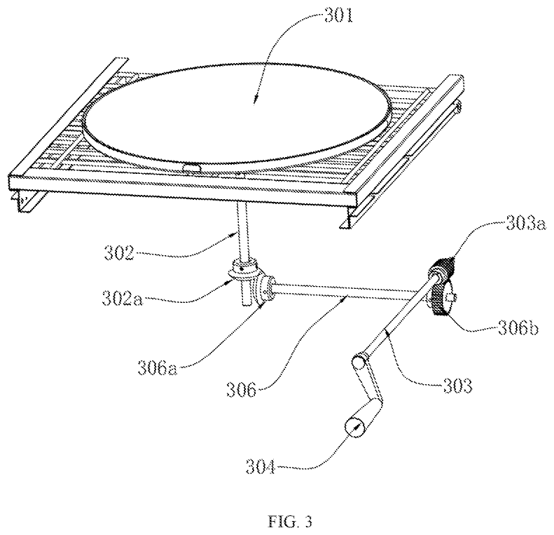

FIG. 3 is a schematic structural view of a turntable mechanism of the pizza oven according to an embodiment of the present application.

The realization, functional characteristics and advantages of the purpose of the present application will be further described with reference to the drawings in combination with the embodiments.

### DETAILED DESCRIPTION OF THE EMBODIMENTS

The technical solutions in the embodiments of the present application will be clearly and completely described below with reference to the accompanying drawings in the embodiments of the present present application. Obviously, the described embodiments are only a part of the embodiments of the present present application, rather than all of the embodiments. Based on the embodiments in the present application, all other embodiments obtained by ordinary technicians in the art without making creative labor belong to the claimed scope of the present application.

It should be noted that if a directional indication (such as up, down, left, right, front, back, etc.) is involved in the embodiments of the present application, the directional indication is only used to explain the relative positional relationship, movement situation, etc. between the components in a specific posture, and if the specific posture changes, the directional indication also changes accordingly.

In addition, if there is a description relating to “first”, “second” and the like in the embodiments of the present application, the description of “first”, “second” and the like is only used for the purpose of description, and cannot be understood as indicating or implying the relative importance thereof or implicitly indicating the number of technical features indicated. Thus, the feature defined with “first” and “second” may explicitly or implicitly include at least one such feature. In addition, if “and/or” appears in the full text, it means that three parallel schemes are included, taking “A and/or B” as an example, “A and/or B” includes scheme A, scheme B. or both schemes A and B. In addition, the technical solutions between the various embodiments may be combined with each other, but the combination must be based on that those of ordinary skill in the art can realize it. When the combination of the technical solutions is contradictory or cannot be realized, it should be considered that the combination of the technical solutions does not exist and is not within the claimed scope of the present application.

The present application provides a pizza oven.

In an embodiment of the present application, referring to FIG. 1. FIG. 2 and FIG. 3 together, the pizza oven includes:
a shell 10 formed with an accommodating cavity 101;
a heating mechanism 20 arranged in the accommodating cavity 101 and configured for heating and baking pizza; and
a turntable mechanism 30 including a turntable 301, a rotating shaft 302, a first transmission rod 303, and a driving member 304. The turntable 301 is configured to hold the pizza to be baked, the turntable 301 is arranged in the accommodating cavity 101, the driving member 304 is located outside the shell 10, a bottom of the turntable 301 is connected with the rotating shaft 302. One end of the first transmission rod 303 is in driving connection with the rotating shaft 302 and configured for driving the rotating shaft 302 to rotate, the other end of the first transmission rod 303 passes through a side of the shell 10 and is connected to the driving member 304, and the driving member 304 can drive the first transmission rod 303 to rotate the rotating shaft 302 and then rotate the turntable 301.

In the technical solution of the present application, the driving member 304 is arranged outside the shell 10, and the driving member 304 is drivingly connected with the rotating shaft 302 through the first transmission rod 303, and can drive the rotating shaft 302 to rotate and then the turntable 301 is rotated, so that the pizza on the turntable 301 is heated evenly and a baking effect of the pizza oven baking the pizza is improved. Because the driving member 304 is arranged outside the shell 10, when the driving member 304 of the turntable mechanism 30 is damaged, it does not need to disassemble the shell 10 and remove the driving member 304 from the accommodating cavity 101, and only needs to replace or repair the driving member 304 outside the shell 10, which is simple to operate and improves the maintenance efficiency of the pizza oven.

In an embodiment, according to FIG. 3, the driving member 304 is a hand crank, a driving end of the hand crank is connected to an end of the first transmission rod 303 away from the rotating shaft 302, and a rotating speed of the turntable 301 can be controlled by rotating and controlling the hand crank. Because the rotating speed of the turntable 301 required for different time periods of pizza baking is different, the rotating speed of the turntable 301 can be controlled in stages and personalized, which can improve a baking effect of the pizza oven baking the pizza.

In another embodiment, not shown in the figures, the driving member 304 is a driving motor, and a driving end of the driving motor is connected to the end of the first transmission rod 303 away from the rotating shaft 302. By controlling the turning on or off of the driving motor, a rotation of the turntable 301 can be controlled, the operation is simple, the automation level is high, and the baking efficiency of the pizza oven can be improved.

In an embodiment, according to FIG. 2, the turntable mechanism 30 further includes a supporting beam 305. The supporting beam 305 is arranged in the accommodating cavity 101 and provided with a rotating hole for passing the rotating shaft 302. The rotating hole of the supporting beam 305 is provided with a bearing connected with the rotating shaft 302. When to install the rotating shaft 302, the rotating shaft 302 can be make to pass through the rotating hole of the supporting beam 305, and then connected with the turntable 301. The supporting beam 305 can support the rotating shaft 302 and improve structural stability of the rotating shaft 302. In addition, the bearing at the rotating hole of the supporting beam 305 can improve smoothness of rotation of the rotating shaft 302, preventing the rotating shaft 302 from being stuck.

In an embodiment, according to FIG. 3, the turntable mechanism 30 further includes a second transmission rod 306. One end of the second transmission rod 306 is provided with a first transmission wheel 306a connected with the rotating shaft 302, and the other end of the second transmission rod 306 is provided with a transmission gear 306b connected with the first transmission rod 303. An end of the rotating shaft 302 away from the turntable 301 is provided with a second transmission wheel 302a connected with the first transmission wheel 306a. The first transmission wheel 306a and the second transmission wheel 302a are both sector gears. The two sector gears are meshed. The end of the first transmission rod 303 far away from the driving member 304 is provided with a thread 303a connected with the transmission gear 306b. Since a position of the driving member 304 relative to the shell 10 needs to be adjusted according to actual usage conditions, the second transmission rod 306 added can adjust the position of the driving member 304. The four parts, i.e. the first transmission wheel 306a and the transmission gear 306b arranged on the second transmission rod 306, the thread 303a provided on the first transmission rod 303 and the second transmission wheel 302a provided on the rotating shaft 302, are connected in pairs, which can improve the overall structural stability of the turntable mechanism 30 and ensure that the turntable 301 can rotate normally.

In an embodiment, according to FIG. 2 and FIG. 3, one end of the second transmission rod 306 is provided with a first protective cover 307, the other end of the second transmission rod 306 is provided with a second protective cover 308. The first protective cover 307 wraps the first transmission wheel 306a and the second transmission wheel 302a, and the second protective cover 308 wraps the transmission gear 306b and the thread 303a. Because certain cooking fumes and impurities will be generated during pizza baking, the first protective cover 307 and the second protective cover 308 can protect these important transmission parts and prevent the turntable mechanism 30 from being damaged due to the influence of oil smoke and impurities.

In an embodiment, according to FIG. 2, the heating mechanism 20 includes at least one heating tube 201 located below the turntable 301. The heating mechanism 20 is further provided with a control knob for controlling the turning on or off of the heating tube 201 and a heating temperature, and the turning on or off of the heating tube 201 and the heating temperature can be controlled through the control knob to heat and bake the pizza on the turntable 301.

Optionally, according to FIG. 2, a first grille 102 and a second grille 103 are arranged in the accommodating cavity 101. The turntable 301 is located between the first grille 102 and the second grille 103. The turntable 301 is heated at a lower part thereof and an upper part thereof emits fumes. Since the turntable 301 is located between the first grille 102 and the second grille 103, the first grille 102 and the second grille 103 can make the turntable 301 heated more evenly and exhaust the fumes more evenly.

Optionally, according to FIG. 1, the shell 10 is provided with an opening 104 for taking out the pizza. The opening 104 of the shell 10 is provided with an oven door 105, and the oven door 105 is provided with a door lock 106 for controlling the opening and closing of the oven door 105. When the pizza needs to be baked, the oven door 105 can be closed through the door lock 106 to make the accommodating cavity 101 closed, increase the heating temperature of the pizza, and bake the pizza. After the pizza is baked, the oven door 105 can be opened through the door lock 106 and the baked pizza is taken out.

Optionally, according to FIG. 1 and FIG. 2, a top of the shell 10 is provided with a smoke exhaust pipe 107. The smoke exhaust pipe 107 is communicated with the accommodating cavity 101, which facilitates the discharge of the oil smoke generated in the pizza baking process, and prevents the oil smoke from adversely affecting the components in the accommodating cavity 101.

The above is only a preferred embodiment of the present application, and does not limit the patent scope of the present application. Any equivalent structural transformation made by using the description of the present application and the accompanying drawings under the concept of the present application, or any direct/indirect application in other related technical fields are included in the claimed scope of the present application.

What is claimed is:

1. A pizza oven, comprising:
a shell formed with an accommodating cavity therein;
a heating mechanism arranged in the accommodating cavity and configured for heating and baking a pizza; and
a turntable mechanism comprising a turntable, a rotating shaft, a first transmission rod and a driving member,
wherein the turntable is arranged in the accommodating cavity, the driving member is located outside the shell, a bottom of the turntable is connected with the rotating shaft, one end of the first transmission rod is drivingly connected with the rotating shaft, and the other end of the first transmission rod is configured to pass through one side of the shell and connected with the driving member, and the driving member is configured to drive the first transmission rod to rotate the rotating shaft to rotate the turntable.

2. The pizza oven according to claim 1, wherein the driving member is a hand crank, and a driving end of the hand crank is connected to the other end of the first transmission rod away from the rotating shaft.

3. The pizza oven according to claim 1, wherein the driving member is a driving motor, and a driving end of the driving motor is connected to the other end of the first transmission rod away from the rotating shaft.

4. The pizza oven according to claim 1, wherein the turntable mechanism further comprises a supporting beam arranged in the accommodating cavity, the supporting beam is provided with a rotating hole for the rotating shaft to pass through, and a bearing connected with the rotating shaft is arranged at the rotating hole of the supporting beam.

5. The pizza oven according to claim 1, wherein the turntable mechanism further comprises a second transmission rod, one end of the second transmission rod is provided with a first transmission wheel connected with the rotating shaft, the other end of the second transmission rod is provided with a transmission gear connected with the first transmission rod, an end of the rotating shaft away from the turntable is provided with a second transmission wheel connected with the first transmission wheel, the one end of the first transmission rod away from the driving member is provided with a thread connected with the transmission gear.

6. The pizza oven according to claim 5, wherein one end of the second transmission rod is provided with a first protective cover, and the other end of the second transmission rod is provided with a second protective cover, the first protective cover wraps the first transmission wheel and the second transmission wheel, and the second protective cover wraps the transmission gear and the thread.

7. The pizza oven according to claim 1, wherein the heating mechanism comprises at least one heating tube located below the turntable.

8. The pizza oven according to claim 1, wherein a first grille and a second grille are provided in the accommodating cavity, and the turntable is located between the first grille and the second grille.

9. The pizza oven according to claim 1, wherein the shell is provided with an opening for taking out the pizza, an oven door is provided at the opening of the shell, and the oven door is provided with a door lock for controlling opening and closing of the oven door.

10. The pizza oven according to claim 1, wherein a smoke exhaust pipe is arranged at a top of the shell and in communication with the accommodating cavity.
